(19) United States
(12) Patent Application Publication
(10) Pub. No.: US 2022/0036126 A1
(43) Pub. Date: Feb. 3, 2022

(54) SYSTEM AND METHOD FOR TRAINING OF A DETECTOR MODEL TO OUTPUT AN INSTANCE IDENTIFIER INDICATING OBJECT CONSISTENCY ALONG THE TEMPORAL AXIS

(71) Applicant: Toyota Research Institute, Inc., Los Altos, CA (US)

(72) Inventors: Adrien David Gaidon, Mountain View, CA (US); Jie Li, Los Altos, CA (US)

(21) Appl. No.: 16/943,393

(22) Filed: Jul. 30, 2020

(51) Int. Cl. G06K 9/62; G06N 20/00; G06T 7/70

(52) U.S. Cl. CPC G06K 9/6256; G06N 20/00; G06K 9/6267; G06K 9/6253; G06T 2207/10024; G06T 7/70; G06T 2207/20081; G06T 2207/30252; G06K 9/6215

(57) ABSTRACT

A detector system having a detector model includes one or more processor(s) and a memory. The memory includes an image acquisition module, a training module, and a label propagating module. The modules cause the processor(s) to obtain a first training set, train the detector model using the first training set and a first loss function, label propagate a second training set by the detector model after the detector model is trained with the first training set, and train the detector model using the first training set, the second training set, the first loss function, and a discriminative loss function. The detector model is trained through an intermediate multidimensional feature predicted at each pixel location of the one or more objects of the first training set and the second training set. The intermediate multidimensional feature being an instance identifier expressing the temporal consistency of objects along the temporal axis.

### TECHNICAL FIELD

The subject matter described herein relates, in general, to systems and methods for training detector models for object detection systems.

### BACKGROUND

The background description provided is to present the context of the disclosure generally. Work of the inventor, to the extent it may be described in this background section, and aspects of the description that may not otherwise qualify as prior art at the time of filing, are neither expressly nor impliedly admitted as prior art against the present technology.

Some current vehicles have detector systems that utilize detector models that can determine the location of one or more objects within an image, such as an image captured by a camera mounted to the vehicle. These detector models are usually trained in a supervised, semi-supervised, or even self-supervised fashion, wherein the detector model is able to output an object location and/or class label for each object detected.

However, detector systems may have some drawbacks. For example, due to issues that may arise with capturing images from an externally mounted camera, location of shadows, and issues with the detector model itself, objects detected within images may not be consistent. For example, objects detected in one image by the detector model may not be detected in the next image. As such, this causes issues with downstream processes, such as object tracking and motion planning.

### SUMMARY

This section generally summarizes the disclosure and is not a comprehensive explanation of its full scope or all its features.

In one embodiment, a method for training a detector model of a detector system includes the steps of obtaining a first training set that includes images having pixels that form one or more objects, training the detector model using the first training set and a first loss function, label propagating a second training set by the detector model after the detector model is trained with the first training set, and training the detector model using the first training set, the second training set, the first loss function, and a discriminative loss function.

The first training set includes images, each having pixels that form one or more objects. The pixels of the images are annotated with a known object location and a known class label. The first loss function expresses a difference between the known object location and the known class label for the one or more objects and a predicted object location and a predicted class label for the one or more objects as predicted by the detector model. As such, the initial training of the detector model allows the detector model to determine an object location and object class for each detected object.

Like the first training set, the second training set includes images having pixels that form one or more objects. The images of the second training set are sequentially associated with at least one image of the first training set. The second training set is label propagated using the detector model that was trained using the first training set and the first loss function, such that objects within the images of the second training set are annotated with object location and object class information.

The detector model undergoes a second training using the first training set, the second training set, the first loss function, and a discriminative loss function. Here, the object detector model learns an instance identifier from the known object location of the one or more objects of the first training set and the second training set using the discriminative loss function. The instance identifier expresses the temporal consistency of the one or more objects along the temporal axis. The detector model is trained through an intermediate multidimensional feature predicted at each pixel location of the one or more objects of the first training set and the second training set. The intermediate multidimensional feature is the instance identifier.

In another embodiment, a detector system has a detector model and further includes one or more processors and a memory in communication with the one or more processors. The memory includes an image acquisition module, a training module, and a label propagating module. The image acquisition module has instructions that, when executed by the one or more processors, cause the one or more processors to obtain a first training set that includes images each having pixels that form one or more objects. The one or more objects are each annotated with a known object location and a known class label.

The training module has instructions that, when executed by the one or more processors, cause the one or more processors to train the detector model using the first training set and a first loss function. The first loss function expresses a difference between the known object location and the known class label for the one or more objects and a predicted object location and a predicted class label for the one or more objects as predicted by the detector model.

The label propagating module has instructions that, when executed by the one or more processors, cause the one or more processors to label propagate a second training set by the detector model after the detector model is trained with the first training set. The images of the second training set are sequentially associated with at least one image of the first training set.

The training module performs a second training of the detector model. As such, the training module further has instructions that, when executed by the one or more processors, cause the one or more processors to train the detector model using the first training set, the second training set, the first loss function, and a discriminative loss function. The object detector model learns an instance identifier from the known object location of the one or more objects of the first training set and the second training set using the discriminative loss function. The instance identifier expresses the temporal consistency of the one or more objects along the temporal axis. The detector model is trained through an intermediate multidimensional feature predicted at each pixel location of the one or more objects of the first training set and the second training set. The intermediate multidimensional feature is the instance identifier.

In yet another embodiment, a non-transitory computer-readable medium storing instructions that, when executed by one or more processors, cause the one or more processors to obtain a first training set that includes images each having pixels, training the detector model using the first training set and a first loss function, label propagate a second training set by the detector model after the detector model is trained with the first training set, and train the detector model using the first training set, the second training set, the first loss function, and a discriminative loss function.

Further areas of applicability and various methods of enhancing the disclosed technology will become apparent from the description provided. The description and specific examples in this summary are intended for illustration only and are not intended to limit the scope of the present disclosure.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments, one element may be designed as multiple elements or multiple elements may be designed as one element. In some embodiments, an element shown as an internal component of another element may be implemented as an external component and vice versa. Furthermore, elements may not be drawn to scale.

FIG. 1 illustrates one example implementation of the detector system that utilizes a detector model within a vehicle.

FIG. 2 illustrates a more detailed view of the detector system.

FIG. 3 illustrates a process flow for training a detector model of the detector system using a first training set and a first loss function.

FIG. 4 illustrates a process flow for label propagating a second training set after the detector model of the detector system is trained with the first training set and the first loss function.

FIG. 5 illustrates a process flow for training the detector model of the detector system with the first training set, the second training set, the first loss function, and the discriminative loss function.

FIG. 6 illustrates a process flow for outputting by the detector system an object location, a class label, and an instance identifier indicating the consistency of an object along the temporal axis; and

FIG. 7 illustrates a method for training a detector model of a detector system.

### DETAILED DESCRIPTION

Described is a system and method for training a detector model utilized by a detection system so as to output an object location, an object class, and an instance identifier for each detected object. The instance identifier indicates the temporal consistency of the detected object along the temporal axis.

The system and method are able to train the detector model in a semi-supervised fashion. In a first training, the detector model is trained using an annotated training set and a first loss function. This initial training allows the detector model to be able to generate the object location and the object class, but not the instance identifier.

A second training of the detector model occurs after a second training set is generated by label propagating labels from the first training set into the second training set. Moreover, for example, an image located within the first training set may have corresponding sequential images in the second training set. Objects within the first training set, which have been annotated, can be label propagated into the second training set, thus increasing the size of the training set.

Once the second training set is created by label propagation, the detector model undergoes the second training, which trains the detector model using both the first and second training sets, the first loss function, and a discriminative loss function. Here, the object detector model learns an instance identifier from the known object location of the one or more objects of the first training set and the second training set using the discriminative loss function. The detector model is trained through an intermediate multidimensional feature predicted at each pixel location of the one or more objects of the first training set and the second training set. The intermediate multidimensional feature is the instance identifier.

Once the second training is completed, the detector model will be able to simultaneously output the object location, object class, and the instance identifier that indicates the consistency of an object along the temporal axis of the detected object. This information can be utilized by downstream processes, such as object trackers, to improve performance.

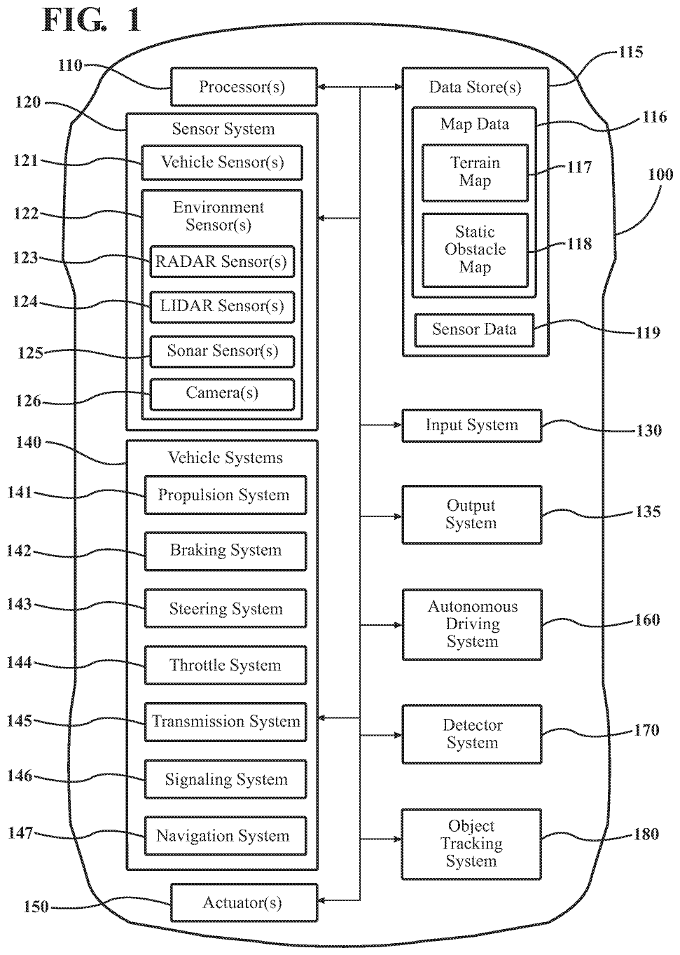

Referring to FIG. 1, an example of a vehicle 100 is illustrated. As used herein, a “vehicle” is any form of powered transport. In one or more implementations, the vehicle 100 is an automobile. While arrangements will be described herein with respect to automobiles, it will be understood that embodiments are not limited to automobiles. In some implementations, the vehicle 100 may be any robotic device or form of powered transport that, for example, includes one or more automated or autonomous systems, and thus benefits from the functionality discussed herein.

In various embodiments, the automated/autonomous systems or combination of systems may vary. For example, in one aspect, the automated system is a system that provides autonomous control of the vehicle according to one or more levels of automation, such as the levels defined by the Society of Automotive Engineers (SAE) (e.g., levels 0-5). As such, the autonomous system may provide semi-autonomous control or fully autonomous control, as discussed in relation to the autonomous driving system 160.

The vehicle 100 also includes various elements. It will be understood that in various embodiments it may not be necessary for the vehicle 100 to have all of the elements shown in FIG. 1. The vehicle 100 can have any combination of the various elements shown in FIG. 1. Further, the vehicle 100 can have additional elements to those shown in FIG. 1. In some arrangements, the vehicle 100 may be implemented without one or more of the elements shown in FIG. 1. While the various elements are shown as being located within the vehicle 100 in FIG. 1, it will be understood that one or more of these elements can be located external to the vehicle 100. Further, the elements shown may be physically separated by large distances and provided as remote services (e.g., cloud-computing services).

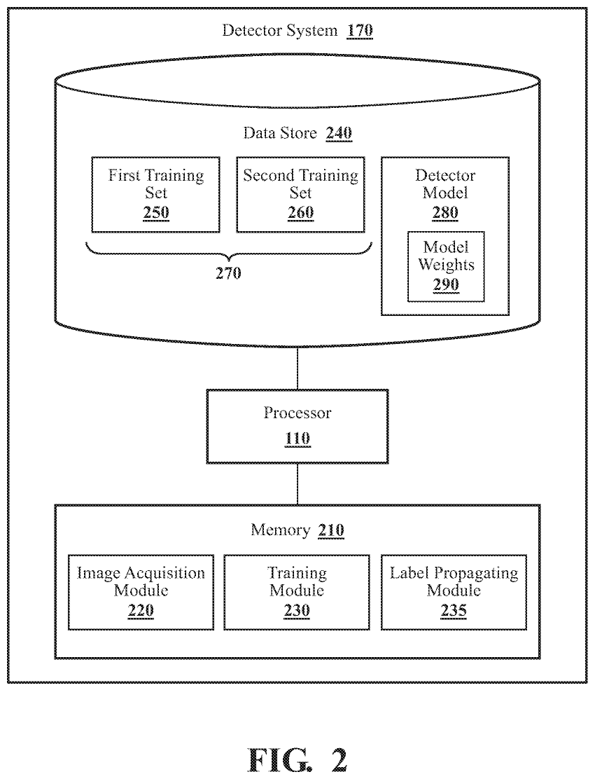

Some of the possible elements of the vehicle 100 are shown in FIG. 1 and will be described along with subsequent figures. However, a description of many of the elements in FIG. 1 will be provided after the discussion of FIGS. 2-7 for purposes of brevity of this description. Additionally, it will be appreciated that for simplicity and clarity of illustration, where appropriate, reference numerals have been repeated among the different figures to indicate corresponding or analogous elements. In addition, the discussion outlines numerous specific details to provide a thorough understanding of the embodiments described herein. It should be understood that the embodiments described herein may be practiced using various combinations of these elements.

In either case, the vehicle 100 includes a detector system 170. The detector system 170 may be incorporated within an autonomous driving system 160 and/or an object tracking system 180 or may be separate as shown. The detector system 170, as will be explained in greater detail later in this specification, can simultaneously output the object location, object class, and the instance identifier that indicates the consistency of an object along the temporal axis of the detected object. This information can be utilized by downstream processes, such as the autonomous driving system 160 and/or the object tracking system 180.

With reference to FIG. 2, one embodiment of the detector system 170 is further illustrated. As shown, the detector system 170 includes a processor(s) 110. Accordingly, the processor(s) 110 may be a part of the detector system 170, or the detector system 170 may access the processor(s) 110 through a data bus or another communication path. In one or more embodiments, the processor(s) 110 is an application-specific integrated circuit that is configured to implement functions associated with an image acquisition module 220, the training module 230, and/or a label propagating module 235. In general, the processor(s) 110 is an electronic processor such as a microprocessor that is capable of performing various functions as described herein. In one embodiment, the detector system 170 includes a memory 210 that stores the image acquisition module 220, the training module 230, and/or the label propagating module 235. The memory 210 is a random-access memory (RAM), read-only memory (ROM), a hard disk drive, a flash memory, or other suitable memory for storing the modules 220, 230, and 235. The modules 220, 230, and 235 are, for example, computer-readable instructions that, when executed by the processor(s) 110, cause the processor(s) 110 to perform the various functions disclosed herein.

Furthermore, in one embodiment, the detector system 170 includes a data store 240. The data store 240 is, in one embodiment, an electronic data structure such as a database that is stored in the memory 210 or another memory and that is configured with routines that can be executed by the processor(s) 110 for analyzing stored data, providing stored data, organizing stored data, and so on. Thus, in one embodiment, the data store 240 stores data used or generated by the modules 220, 230, and/or 235 in executing various functions. In this example, the data store 240 may include a first training set 250, a second training set 260, and/or a detector model 280. The first training set 250 and the second training set 260 may be referred to as a combined training set 270 when combined. The detector model 280 may include one or more model weights 290. As will be explained later, the adjustment of the one or more model weights 290 affects the performance of the detector model 280.

With regard to the image acquisition module 220, the image acquisition module 220 may cause the processor(s) 110 to obtain a first training set 250 that includes images. The first training set 250 may include a plurality of annotated images. The images of the first training set 250 and the second training set 260 may be RGB images that are made up of pixels and may have been captured by a camera, such as camera(s) 126 mounted to the vehicle 100. The pixels of the images of the first training set 250 may form one or more objects. These object(s) are annotated with a known object location and a known class label. The object location may be in the form of a bounding box, while the object class may generally describe the object. Examples of object classes include pedestrian, vehicle, bicycle, etc.

With regards to the second training set 260, as will be explained later, the second training set 260 is a label propagated training set generated after the detector model 280 is trained with the first training set 250 and a first loss function. The second training set 260 may include images that are sequentially associated with images of the first training set 250. For example, the second training set 260 may include an image that occurred at a time before or after an image within the first training set 250. As will be explained later, the detector model 280 is trained a second time, this time using information from the first training set 250, the second training set 260, and two separate loss functions to generate the fully trained detector model 280 which can provide not only object location and class, but also an instance identifier indicating the temporal consistency of an object.

Turning our attention to the modules 220, 230, and 235, the image acquisition module 220 includes instructions that, when executed by the processor(s) 110, cause the processor(s) 110 to obtain the first training set 250. As explained previously, the first training set 250 includes images made up of pixels that form the object(s). The object(s) of the images are annotated with a known object location and a known object class.

The training module 230 includes instructions that, when executed by the processor(s) 110, cause the processor(s) 110 to train the detector model 280 using the first training set 250 and a first loss function. The first loss function expresses a difference between the known object location and the known class label for the one or more objects and a predicted object location and a predicted class label for the one or more objects as predicted by the detector model.

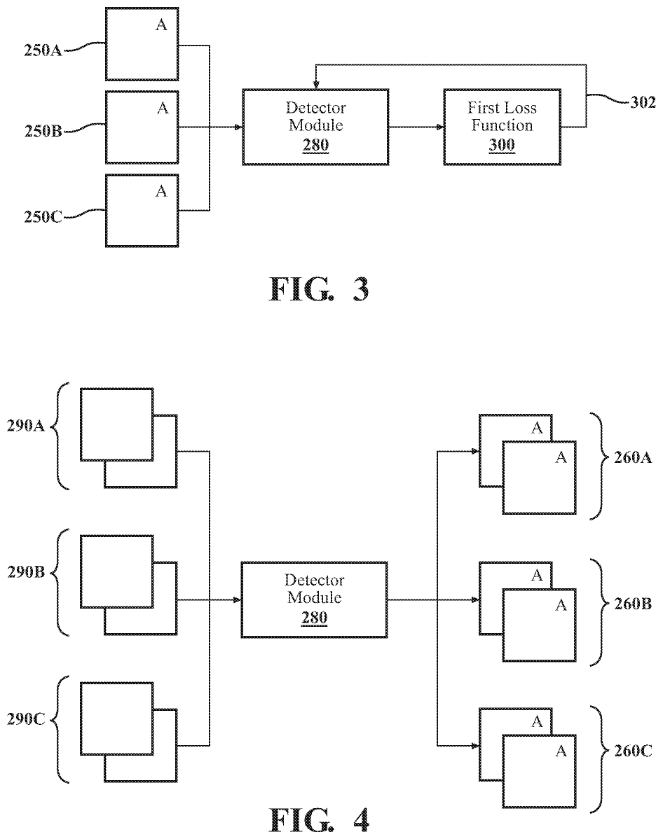

For example, referring to FIG. 3, a process flow for training the detector model 280 using the first training set 250 made up of annotated images 250A-250C are shown. Here, the annotated images 250A-250C are provided to the detector model 280. The detector model 280 attempts to predict the object locations (which may be bounding boxes) and object classes for objects detected in the images 250A-250C. The first loss function 300 determines a loss value 302 between the known object location and the known class label for the one or more objects and a predicted object location and a predicted class label for the one or more objects as predicted by the detector model 280. This type of training is sometimes referred to as supervised training. The loss value 302 is then utilized to adjust the model weights 290 of the detector model 280. Ultimately, the goal is to adjust the model weights 290, such that the loss value 302 is minimized during the training of the detector model 280. As such, once this training is completed, the detector model 280 should be able to predict object locations and object classes for objects located within any input images.

The label propagating module 235 includes instructions that, when executed by the processor(s) 110, cause the processor(s) 110 to label propagate the second training set by the detector model 280. Label propagation is a semi-supervised machine learning algorithm that assigns labels to previously unlabeled data points. Moreover, referring to FIG. 4, the detector model 280 is shown receiving image sets 290A-290C. In this example, the image sets 290A-290C are un-annotated images. Each image set 290A-290C may include one or more images. The image(s) of each image set 290A-290C are associated with at least one annotated image from the first training set 250.

For example, assume the first training set 250 includes an image taken of a scene at time t=1. Also, assume that the images of the image set 290A may be images taken of the same scene at time t=0 and time t=2. Here, using the concept of label propagation, the detector model 280, which was previously trained using the first loss function 300 of FIG. 3 and the first training set 250 can annotate the images forming the image sets 290A-290C. By so doing, the second training set 260 can be generated having images 260A-260C of FIG. 4.

It should be understood that the images of the first training set 250 may have any number of sequentially associated images found in the second training set 260. The example previously given indicated that an image of the first training set 250 may have two sequentially associated images, but it should be understood that any one of a number of images could be sequentially associated with any one image from the first training set. For example, instead of having two images associated with each image of the first training set 250, only one image may be associated with the first training set 250. Either way, the use of label propagation allows for the development of much larger training sets by generating the second training set 260.

The training module 230 may also include instructions that, when executed by the processor(s) 110, cause the processor(s) 110 to perform a second training of the detector model 280. Moreover, as stated previously and shown in FIG. 3, the detector model 280 was trained using the first training set 250 and the first loss function 300 to essentially predict object locations and object classes of objects within input images. As such, for example, the second training of the detector model 280 allows the detector model 280 to output not only objects locations and classes for each object but also consistency along the temporal axis of each object.

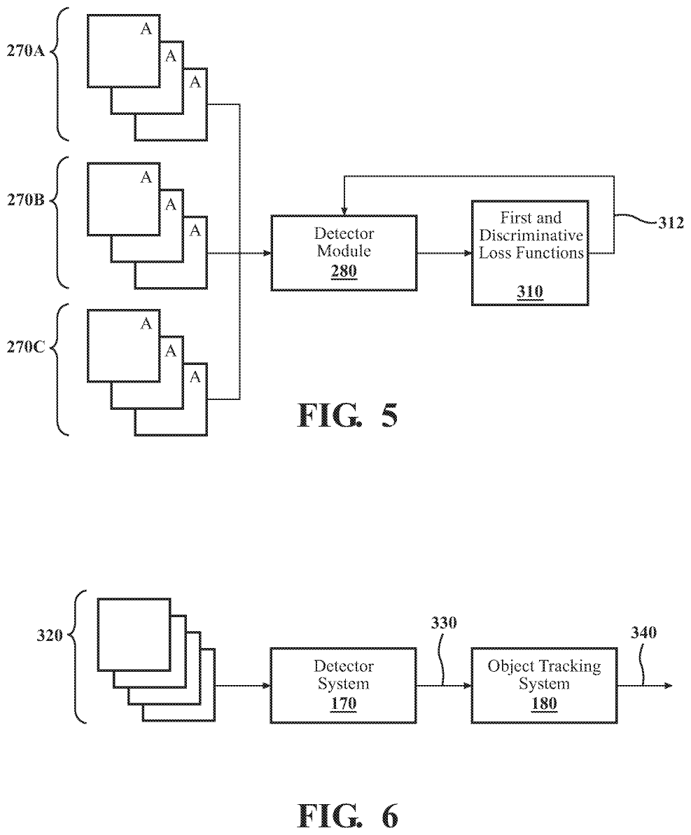

For example, referring to FIG. 5, the detector model 280 is shown. Here, the detector model 280 is trained with a combined training set 270 that combines the first training set 250 with the second training set 260. Here, the combined training set 270 may include images 270A, 270B, and/or 270C. The images 270A may be sequentially associated with each other, while the images 270B and/or 270C may also be sequentially associated with each other, as previously explained. Some of the images of the combined training set 270 have been annotated using label propagation, as explained previously.

During the second training, the detector model 280 receives the images 270A, 270B, and/or 270C and learns an instance identifier from the known object location of the one or more objects of the combined training set 270 using a discriminative loss function. The detector model is trained through an intermediate multidimensional feature predicted at each pixel location of the one or more objects of the combined training set 270. The intermediate multidimensional feature is the instance identifier that expresses the temporal consistency of the one or more objects along the temporal axis. The intermediate multidimensional feature may be n-dimensional vectors of numerical features that represent some object. For example, the intermediate multidimensional feature may be an eight-dimensional feature vector or a twelve-dimensional feature vector

A first loss function and the discriminative loss function 310, which may be two separate loss functions or a single combined loss function. The first loss function expresses a difference between the known object location and the known class label for the one or more objects and a predicted object location and a predicted class label for the one or more objects as predicted by the detector model 280. The discriminative loss function 312 allows the detector model 280 to learn the multi-dimension feature from the object location annotations.

The instance identifier may indicate the temporal consistency of the object(s) detected within images. The temporal consistency of an object refers to the temporal consistency that is associated with a specific object. Moreover, the detector model 280 not only outputs object location and object class but also indicates how consistent the object is (the instance identifier). By so doing, downstream models and systems, such as the object tracking system 180 and/or the autonomous driving system 160 can utilize this information to track objects more effectively and/or perform motion planning for the vehicle 100.

For example, referring to FIG. 6, the detector system 170, includes the detector model 280, receives images 320. The images 320 may be one or more RGB images captured by the camera(s) 126 of the environment sensors 122 of the vehicle 100. The detector system 170 has an output 330 that includes an object location, an object class, and an instance identifier for each object. The output 330 may be provided to an object tracking system 180, which may use this information to track objects detected by the detector system 170. The object tracking system 180 may determine an instance similarity based on the instance identifier. The object tracking system 180 may also have an output 340 that may be used by other systems, such as the autonomous driving system 160.

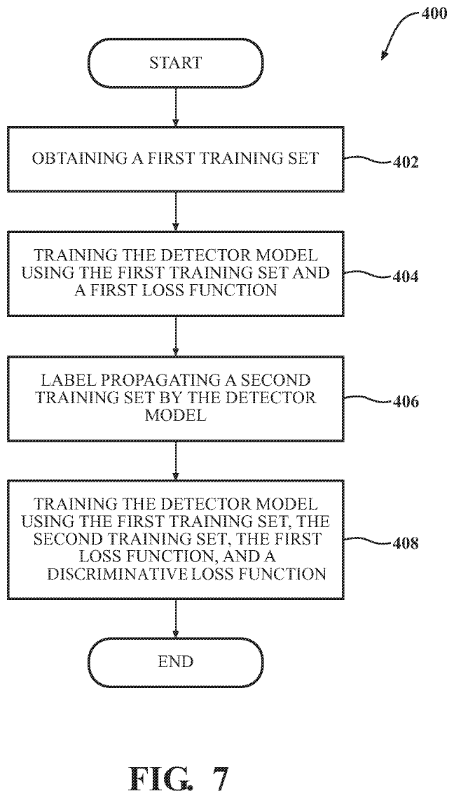

Referring to FIG. 7, a method 400 for training a detector model of a detector system is shown. The method 400 will be described from the viewpoint of the vehicle 100 of FIG. 1 and the detector system 170 of FIG. 2. However, it should be understood that this is just one example of implementing the method 400. While method 400 is discussed in combination with the detector system 170, it should be appreciated that the method 400 is not limited to being implemented within the detector system 170, but is instead one example of a system that may implement the method 400.

The method 400 begins at step 402, wherein the image acquisition module 220 causes the processor(s) 110 to obtain a first training set 250 that includes images. The first training set 250 may include images that include pixels. Objects formed by the pixels of the images of the first training set 250 are annotated with a known object location and a known class label.

In step 404, the training module 230 causes the processor(s) 110 to train the detector model 280 using the first training set 250 and a first loss function. The first loss function expresses a difference between the known object location and the known class label for the one or more objects and a predicted object location and a predicted class label for the one or more objects as predicted by the detector model 280. For example, referring to FIG. 3, a process flow for training the detector model 280 using the first training set 250 made up of annotated images 250A-250C are shown. Here, the annotated images 250A-250C are provided to the detector model 280. The detector model 280 attempts to predict the object locations and classes for objects formed by pixels of the images 250A-250C. The first loss function 300 determines a loss value 302 between the known object location and the known class label for the one or more objects formed by pixels the images 250A-250C and a predicted object location and a predicted class label for the one or more objects formed by pixels of the images 250A-250C as predicted by the detector model 280.

In step 406, the label propagating module 235 causes the processor(s) 110 to label propagate the second training set by the detector model 280. Label propagation is a semi-supervised machine learning algorithm that assigns labels to previously unlabeled data points. Moreover, referring to FIG. 4, the detector model 280 is shown receiving image sets 290A-290C. In this example, the image sets 290A-290C are un-annotated images. Each image set 290A-290C may include one or more images. The image(s) of each image set 290A-290C are associated with at least one annotated image from the first training set 250.

In step 408, training module 230 causes the processor(s) 110 to perform a second training of the detector model 280. M Moreover, as stated previously and shown in FIG. 3, the detector model 280 was trained using the first training set 250 and the first loss function 300 to essentially predict object locations and object classes of objects within input images. As such, for example, the second training of the detector model 280 allows the detector model 280 to output not only objects locations and classes for each object but also consistency along the temporal axis of each object.

For example, referring to FIG. 5, the detector model 280 is shown. Here, the detector model 280 is trained with a combined training set 270 that combines the first training set 250 with the second training set 260. Here, the combined training set 270 may include images 270A, 270B, and/or 270C. The images 270A may be sequentially associated with each other, while the images 270B and/or 270C may also be sequentially associated with each other, as previously explained. Some of the images of the combined training set 270 have been annotated using label propagation, as explained previously.

During the second training, the detector model 280 receives the images 270A, 270B, and/or 270C and learns an instance identifier from the known object location of the one or more objects of the combined training set 270 using a discriminative loss function. The detector model is trained through an intermediate multidimensional feature predicted at each pixel location of the one or more objects of the combined training set 270. The intermediate multidimensional feature is the instance identifier that expresses the temporal consistency of the one or more objects along the temporal axis. Multidimensional feature vectors may be n-dimensional vectors of numerical features that represent some object. For example, the n-dimensional vectors may be an eight-dimensional feature vector or a twelve-dimensional feature vector

Moreover, the detector model 280 will be able to simultaneously output the object location, object class, and the instance identifier that indicates the consistency of an object along the temporal axis of the detected object. This information can be utilized by downstream processes, such as object trackers, to improve performance.

FIG. 1 will now be discussed in full detail as an example environment within which the system and methods disclosed herein may operate. In one or more embodiments, the vehicle 100 is an autonomous vehicle. As used herein, “autonomous vehicle” refers to a vehicle that operates in an autonomous mode. “Autonomous mode” refers to navigating and/or maneuvering the vehicle 100 along a travel route using one or more computing systems to control the vehicle 100 with minimal or no input from a human driver. In one or more embodiments, the vehicle 100 is highly automated or completely automated. In one embodiment, the vehicle 100 is configured with one or more semi-autonomous operational modes in which one or more computing systems perform a portion of the navigation and/or maneuvering of the vehicle 100 along a travel route, and a vehicle operator (i.e., driver) provides inputs to the vehicle to perform a portion of the navigation and/or maneuvering of the vehicle 100 along a travel route. Such semi-autonomous operation can include supervisory control as implemented by the detector system 170 to ensure the vehicle 100 remains within defined state constraints.

The vehicle 100 can include one or more processor(s) 110. In one or more arrangements, the processor(s) 110 can be a main processor of the vehicle 100. For instance, the processor(s) 110 can be an electronic control unit (ECU). The vehicle 100 can include one or more data store(s) 115 for storing one or more types of data. The data store(s) 115 can include volatile and/or non-volatile memory. Examples of data store(s) 115 include RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The data store(s) 115 can be a component of the processor(s) 110, or the data store(s) 115 can be operatively connected to the processor(s) 110 for use thereby. The term “operatively connected,” as used throughout this description, can include direct or indirect connections, including connections without direct physical contact.

In one or more arrangements, the one or more data store(s) 115 can include map data 116. The map data 116 can include maps of one or more geographic areas. In some instances, the map data 116 can include information or data on roads, traffic control devices, road markings, structures, features, and/or landmarks in the one or more geographic areas. The map data 116 can be in any suitable form. In some instances, the map data 116 can include aerial views of an area. In some instances, the map data 116 can include ground views of an area, including 360-degree ground views. The map data 116 can include measurements, dimensions, distances, and/or information for one or more items included in the map data 116 and/or relative to other items included in the map data 116. The map data 116 can include a digital map with information about road geometry. The map data 116 can be high quality and/or highly detailed.

In one or more arrangements, the map data 116 can include one or more terrain map(s) 117. The terrain map(s) 117 can include information about the ground, terrain, roads, surfaces, and/or other features of one or more geographic areas. The terrain map(s) 117 can include elevation data in the one or more geographic areas. The map data 116 can be high quality and/or highly detailed. The terrain map(s) 117 can define one or more ground surfaces, which can include paved roads, unpaved roads, land, and other things that define a ground surface.

In one or more arrangements, the map data 116 can include one or more static obstacle map(s) 118. The static obstacle map(s) 118 can include information about one or more static obstacles located within one or more geographic areas. A “static obstacle” is a physical object whose position does not change or substantially change over a period of time and/or whose size does not change or substantially change over a period of time. Examples of static obstacles include trees, buildings, curbs, fences, railings, medians, utility poles, statues, monuments, signs, benches, furniture, mailboxes, large rocks, hills. The static obstacles can be objects that extend above ground level. The one or more static obstacles included in the static obstacle map(s) 118 can have location data, size data, dimension data, material data, and/or other data associated with it. The static obstacle map(s) 118 can include measurements, dimensions, distances, and/or information for one or more static obstacles. The static obstacle map(s) 118 can be high quality and/or highly detailed. The static obstacle map(s) 118 can be updated to reflect changes within a mapped area.

The one or more data store(s) 115 can include sensor data 119. In this context, “sensor data” means any information about the sensors that the vehicle 100 is equipped with, including the capabilities and other information about such sensors. As will be explained below, the vehicle 100 can include the sensor system 120. The sensor data 119 can relate to one or more sensors of the sensor system 120. As an example, in one or more arrangements, the sensor data 119 can include information on one or more LIDAR sensors 124 of the sensor system 120.

In some instances, at least a portion of the map data 116 and/or the sensor data 119 can be located in one or more data store(s) 115 located onboard the vehicle 100. Alternatively, or in addition, at least a portion of the map data 116 and/or the sensor data 119 can be located in one or more data store(s) 115 that are located remotely from the vehicle 100.

As noted above, the vehicle 100 can include the sensor system 120. The sensor system 120 can include one or more sensors. “Sensor” means any device, component, and/or system that can detect, and/or sense something. The one or more sensors can be configured to detect, and/or sense in real-time. As used herein, the term “real-time” means a level of processing responsiveness that a user or system senses as sufficiently immediate for a particular process or determination to be made, or that enables the processor to keep up with some external process.

In arrangements in which the sensor system 120 includes a plurality of sensors, the sensors can work independently from each other. Alternatively, two or more of the sensors can work in combination with each other. In such a case, the two or more sensors can form a sensor network. The sensor system 120 and/or the one or more sensors can be operatively connected to the processor(s) 110, the data store(s) 115, and/or another element of the vehicle 100 (including any of the elements shown in FIG. 1). The sensor system 120 can acquire data of at least a portion of the external environment of the vehicle 100 (e.g., nearby vehicles).

The sensor system 120 can include any suitable type of sensor. Various examples of different types of sensors will be described herein. However, it will be understood that the embodiments are not limited to the particular sensors described. The sensor system 120 can include one or more vehicle sensor(s) 121. The vehicle sensor(s) 121 can detect, determine, and/or sense information about the vehicle 100 itself. In one or more arrangements, the vehicle sensor(s) 121 can be configured to detect, and/or sense position and orientation changes of the vehicle 100, such as, for example, based on inertial acceleration. In one or more arrangements, the vehicle sensor(s) 121 can include one or more accelerometers, one or more gyroscopes, an inertial measurement unit (IMU), a dead-reckoning system, a global navigation satellite system (GNSS), a global positioning system (GPS), a navigation system 147, and/or other suitable sensors. The vehicle sensor(s) 121 can be configured to detect, and/or sense one or more characteristics of the vehicle 100. In one or more arrangements, the vehicle sensor(s) 121 can include a speedometer to determine a current speed of the vehicle 100.

Alternatively, or in addition, the sensor system 120 can include one or more environment sensors 122 configured to acquire, and/or sense driving environment data. “Driving environment data” includes data or information about the external environment in which an autonomous vehicle is located or one or more portions thereof. For example, the one or more environment sensors 122 can be configured to detect, quantify and/or sense obstacles in at least a portion of the external environment of the vehicle 100 and/or information/data about such obstacles. Such obstacles may be stationary objects and/or dynamic objects. The one or more environment sensors 122 can be configured to detect, measure, quantify and/or sense other things in the external environment of the vehicle 100, such as, for example, lane markers, signs, traffic lights, traffic signs, lane lines, crosswalks, curbs proximate the vehicle 100, off-road objects, etc.

Various examples of sensors of the sensor system 120 will be described herein. The example sensors may be part of the one or more environment sensors 122 and/or the one or more vehicle sensor(s) 121. However, it will be understood that the embodiments are not limited to the particular sensors described.

As an example, in one or more arrangements, the sensor system 120 can include one or more radar sensors 123, one or more LIDAR sensors 124, one or more sonar sensors 125, and/or one or more camera(s) 126. In one or more arrangements, the one or more camera(s) 126 can be high dynamic range (HDR) cameras or infrared (IR) cameras.

The vehicle 100 can include an input system 130. An “input system” includes any device, component, system, element, or arrangement or groups thereof that enable information/data to be entered into a machine. The input system 130 can receive an input from a vehicle passenger (e.g., a driver or a passenger). The vehicle 100 can include an output system 135. An “output system” includes any device, component, or arrangement or groups thereof that enable information/data to be presented to a vehicle passenger (e.g., a person, a vehicle passenger, etc.).

The vehicle 100 can include one or more vehicle systems 140. Various examples of the one or more vehicle systems 140 are shown in FIG. 1. However, the vehicle 100 can include more, fewer, or different vehicle systems. It should be appreciated that although particular vehicle systems are separately defined, each or any of the systems or portions thereof may be otherwise combined or segregated via hardware and/or software within the vehicle 100. The vehicle 100 can include a propulsion system 141, a braking system 142, a steering system 143, throttle system 144, a transmission system 145, a signaling system 146, and/or a navigation system 147. Each of these systems can include one or more devices, components, and/or a combination thereof, now known or later developed.

The navigation system 147 can include one or more devices, applications, and/or combinations thereof, now known or later developed, configured to determine the geographic location of the vehicle 100 and/or to determine a travel route for the vehicle 100. The navigation system 147 can include one or more mapping applications to determine a travel route for the vehicle 100. The navigation system 147 can include a global positioning system, a local positioning system, or a geolocation system.

The processor(s) 110, the detector system 170, and/or the autonomous driving system 160 can be operatively connected to communicate with the vehicle systems 140 and/or individual components thereof. For example, returning to FIG. 1, the processor(s) 110 and/or the autonomous driving system 160 can be in communication to send and/or receive information from the vehicle systems 140 to control the movement, speed, maneuvering, heading, direction, etc. of the vehicle 100. The processor(s) 110 and/or the autonomous driving system 160 may control some or all of these vehicle systems 140 and, thus, may be partially or fully autonomous.

The processor(s) 110 and/or the autonomous driving system 160 can be operatively connected to communicate with the vehicle systems 140 and/or individual components thereof. For example, returning to FIG. 1, the processor(s) 110 and/or the autonomous driving system 160 can be in communication to send and/or receive information from the vehicle systems 140 to control the movement, speed, maneuvering, heading, direction, etc. of the vehicle 100. The processor(s) 110 and/or the autonomous driving system 160 may control some or all of these vehicle systems 140.

The processor(s) 110 and/or the autonomous driving system 160 may be operable to control the navigation and/or maneuvering of the vehicle 100 by controlling one or more of the vehicle systems 140 and/or components thereof. For instance, when operating in an autonomous mode, the processor(s) 110 and/or the autonomous driving system 160 can control the direction and/or speed of the vehicle 100. The processor(s) 110 and/or the autonomous driving system 160 can cause the vehicle 100 to accelerate (e.g., by increasing the supply of fuel provided to the engine), decelerate (e.g., by decreasing the supply of fuel to the engine and/or by applying brakes) and/or change direction (e.g., by turning the front two wheels). As used herein, “cause” or “causing” means to make, force, direct, command, instruct, and/or enable an event or action to occur or at least be in a state where such event or action may occur, either in a direct or indirect manner.

The vehicle 100 can include one or more actuators 150. The actuators 150 can be any element or combination of elements operable to modify, adjust and/or alter one or more of the vehicle systems 140 or components thereof to responsive to receiving signals or other inputs from the processor(s) 110 and/or the autonomous driving system 160. Any suitable actuator can be used. For instance, the one or more actuators 150 can include motors, pneumatic actuators, hydraulic pistons, relays, solenoids, and/or piezoelectric actuators, just to name a few possibilities.

The vehicle 100 can include one or more modules, at least some of which are described herein. The modules can be implemented as computer-readable program code that, when executed by a processor(s) 110, implement one or more of the various processes described herein. One or more of the modules can be a component of the processor(s) 110, or one or more of the modules can be executed on and/or distributed among other processing systems to which the processor(s) 110 is operatively connected. The modules can include instructions (e.g., program logic) executable by one or more processor(s) 110. Alternatively, or in addition, one or more data store(s) 115 may contain such instructions.

In one or more arrangements, one or more of the modules described herein can include artificial or computational intelligence elements, e.g., neural network, fuzzy logic, or other machine learning algorithms. Further, in one or more arrangements, one or more of the modules can be distributed among a plurality of the modules described herein. In one or more arrangements, two or more of the modules described herein can be combined into a single module.

The vehicle 100 can include an autonomous driving system 160. The autonomous driving system 160 can be configured to receive data from the sensor system 120 and/or any other type of system capable of capturing information relating to the vehicle 100 and/or the external environment of the vehicle 100. In one or more arrangements, the autonomous driving system 160 can use such data to generate one or more driving scene models. The autonomous driving system 160 can determine the position and velocity of the vehicle 100. The autonomous driving system 160 can determine the location of obstacles, obstacles, or other environmental features, including traffic signs, trees, shrubs, neighboring vehicles, pedestrians, etc.

The autonomous driving system 160 can be configured to receive, and/or determine location information for obstacles within the external environment of the vehicle 100 for use by the processor(s) 110, and/or one or more of the modules described herein to estimate position and orientation of the vehicle 100, vehicle position in global coordinates based on signals from a plurality of satellites, or any other data and/or signals that could be used to determine the current state of the vehicle 100 or determine the position of the vehicle 100 with respect to its environment for use in either creating a map or determining the position of the vehicle 100 in respect to map data.

The autonomous driving system 160 can be configured to determine travel path(s), current autonomous driving maneuvers for the vehicle 100, future autonomous driving maneuvers and/or modifications to current autonomous driving maneuvers based on data acquired by the sensor system 120, driving scene models, and/or data from any other suitable source such as determinations. “Driving maneuver” means one or more actions that affect the movement of a vehicle. Examples of driving maneuvers include accelerating, decelerating, braking, turning, moving in a lateral direction of the vehicle 100, changing travel lanes, merging into a travel lane, and/or reversing, just to name a few possibilities. The autonomous driving system 160 can be configured to implement determined driving maneuvers. The autonomous driving system 160 can cause, directly or indirectly, such autonomous driving maneuvers to be implemented. As used herein, “cause” or “causing” means to make, command, instruct, and/or enable an event or action to occur or at least be in a state where such event or action may occur, either in a direct or indirect manner. The autonomous driving system 160 can be configured to execute various vehicle functions and/or to transmit data to, receive data from, interact with, and/or control the vehicle 100 or one or more systems thereof (e.g., one or more of vehicle systems 140).

Detailed embodiments are disclosed herein. However, it is to be understood that the disclosed embodiments are intended only as examples. Therefore, specific structural and functional details disclosed herein are not to be interpreted as limiting, but merely as a basis for the claims and as a representative basis for teaching one skilled in the art to variously employ the aspects herein in virtually any appropriately detailed structure. Further, the terms and phrases used herein are not intended to be limiting but rather to provide an understandable description of possible implementations. Various embodiments are shown in FIGS. 1-7, but the embodiments are not limited to the illustrated structure or application.

The flowcharts and block diagrams in the figures illustrate the architecture, functionality, and operation of possible implementations of systems, methods, and computer program products according to various embodiments. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

The systems, components and/or processes described above can be realized in hardware or a combination of hardware and software and can be realized in a centralized fashion in one processing system or in a distributed fashion where different elements are spread across several interconnected processing systems. Any kind of processing system or another apparatus adapted for carrying out the methods described herein is suited. A typical combination of hardware and software can be a processing system with computer-usable program code that, when being loaded and executed, controls the processing system such that it carries out the methods described herein. The systems, components and/or processes also can be embedded in a computer-readable storage, such as a computer program product or other data programs storage device, readable by a machine, tangibly embodying a program of instructions executable by the machine to perform methods and processes described herein. These elements also can be embedded in an application product which comprises all the features enabling the implementation of the methods described herein and, which when loaded in a processing system, is able to carry out these methods.

Furthermore, arrangements described herein may take the form of a computer program product embodied in one or more computer-readable media having computer-readable program code embodied, e.g., stored, thereon. Any combination of one or more computer-readable media may be utilized. The computer-readable medium may be a computer-readable signal medium or a computer-readable storage medium. The phrase “computer-readable storage medium” means a non-transitory storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: a portable computer diskette, a hard disk drive (HDD), a solid-state drive (SSD), a read-only memory (ROM), an erasable programmable read-only memory (EPROM or Flash memory), a portable compact disc read-only memory (CD-ROM), a digital versatile disc (DVD), an optical storage device, a magnetic storage device, or any suitable combination of the foregoing. In the context of this document, a computer-readable storage medium may be any tangible medium that can contain or store a program for use by or in connection with an instruction execution system, apparatus, or device.

Generally, module, as used herein, includes routines, programs, objects, components, data structures, and so on that perform particular tasks or implement particular data types. In further aspects, a memory generally stores the noted modules. The memory associated with a module may be a buffer or cache embedded within a processor, a RAM, a ROM, a flash memory, or another suitable electronic storage medium. In still further aspects, a module as envisioned by the present disclosure is implemented as an application-specific integrated circuit (ASIC), a hardware component of a system on a chip (SoC), as a programmable logic array (PLA), or as another suitable hardware component that is embedded with a defined configuration set (e.g., instructions) for performing the disclosed functions.

Program code embodied on a computer-readable medium may be transmitted using any appropriate medium, including but not limited to wireless, wireline, optical fiber, cable, RF, etc., or any suitable combination of the foregoing. Computer program code for carrying out operations for aspects of the present arrangements may be written in any combination of one or more programming languages, including an object-oriented programming language such as Java™, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The phrase “at least one of . . . and . . . ” as used herein refers to and encompasses any and all possible combinations of one or more of the associated listed items. As an example, the phrase “at least one of A, B, and C” includes A only, B only, C only, or any combination thereof (e.g., AB, AC, BC, or ABC).

Aspects herein can be embodied in other forms without departing from the spirit or essential attributes thereof. Accordingly, reference should be made to the following claims, rather than to the foregoing specification, as indicating the scope hereof.

What is claimed is:

1. A method for training a detector model of a detector system, the method comprising the steps of:
obtaining a first training set that includes images having pixels that form one or more objects, the one or more objects being annotated with a known object location and a known class label;
training the detector model using the first training set and a first loss function, the first loss function expresses a difference between the known object location and the known class label for the one or more objects and a predicted object location and a predicted class label for the one or more objects as predicted by the detector model;
label propagating a second training set by the detector model after the detector model is trained with the first training set, the second training set includes images having pixels that form one or more objects, the images of the second training set are sequentially associated with at least one image of the first training set; and
training the detector model using the first training set, the second training set, the first loss function, and a discriminative loss function, wherein the detector model learns an instance identifier from the known object location of the one or more objects of the first training set and the second training set using the discriminative loss function, the instance identifier expressing a temporal consistency of the one or more objects along a temporal axis, wherein the detector model is trained through an intermediate multidimensional feature predicted at each pixel location of the one or more objects of the first training set and the second training set, the intermediate multidimensional feature being the instance identifier.

2. The method of claim 1, wherein, after the detector model is trained with the first training set, the second training set, the first loss function, and the discriminative loss function, the detector model outputs, for a detected object within an input image, a detected object location, a detected class label, and a detected instance identifier indicating a consistency of the detected object along the temporal axis.

3. The method of claim 2, further comprising the step of outputting the instance identifier to an object tracking system.

4. The method of claim 3, further comprising the step of determining by the object tracking model system an instance similarity based on the instance identifier.

5. The method of claim 1, wherein the images of the first training set and the second training set are RGB images captured by a camera mounted to a vehicle.

6. The method of claim 1, wherein the intermediate multidimensional feature is one of an eight-dimensional feature vector or a twelve-dimensional feature vector.

7. The method of claim 1, wherein the detector model is trained in a semi-supervised manner.

8. A detector system having a detector model, the detector system comprising:
one or more processors; and
a memory in communication with the one or more processors, the memory having:
an image acquisition module, the image acquisition module having instructions that, when executed by the one or more processors, cause the one or more processors to obtain a first training set that includes images each having pixels that form one or more objects, the one or more objects being annotated with a known object location and a known class label,
a training module, the training module having instructions that, when executed by the one or more processors, cause the one or more processors to train the detector model using the first training set and a first loss function, the first loss function expresses a difference between the known object location and the known class label for the one or more objects and a predicted object location and a predicted class label for the one or more objects as predicted by the detector model,
a label propagating module, the label propagating module having instructions that, when executed by the one or more processors, cause the one or more processors to label propagate a second training set by the detector model after the detector model is trained with the first training set, the second training set includes images having pixels that form one or more objects, the images of the second training set are sequentially associated with at least one image of the first training set, and
the training module further having instructions that, when executed by the one or more processors, cause the one or more processors to train the detector model using the first training set, the second training set, the first loss function, and a discriminative loss function, wherein the object detector model learns an instance identifier from the known object location of the one or more objects of the first training set and the second training set using the discriminative loss function, the instance identifier expressing a temporal consistency of the one or more objects along a temporal axis, wherein the detector model is trained through an intermediate multidimensional feature predicted at each pixel location of the one or more objects of the first training set and the second training set, the intermediate multidimensional feature being the instance identifier.

9. The system of claim 8, wherein, after the detector model is trained with the first training set, the second training set, the first loss function, and the discriminative loss function, the detector model is configured to output, for a detected object within an input image, a detected object location, a detected class label, and a detected instance identifier indicating a consistency of the detected object along the temporal axis.

10. The system of claim 9, wherein, after the detector model is trained with the first training set, the second training set, the first loss function, and the discriminative loss function, the detector model is configured to output the instance identifier to an object tracking system.

11. The system of claim 10, further comprising an object tracking system configured to determine an instance similarity based on the instance identifier.

12. The system of claim 8, wherein the images of the first training set and the second training set are RGB images captured by a camera mounted to a vehicle.

13. The system of claim 8, wherein the intermediate multidimensional feature is one of an eight-dimensional feature vector or a twelve-dimensional feature vector.

14. The system of claim 8, wherein the detector model is trained in a semi-supervised manner.

15. A non-transitory computer-readable medium storing instruction that, when executed by one or more processors, cause the one or more processors to:
obtain a first training set that includes images having pixels that form one or more objects, the one or more objects being annotated with a known object location and a known class label;
train a detector model using the first training set and a first loss function, the first loss function expresses a difference between the known object location and the known class label for the one or more objects and a predicted object location and a predicted class label for the one or more objects as predicted by the detector model;
label propagate a second training set by the detector model after the detector model is trained with the first training set, the second training set includes images having pixels that form one or more objects, the images of the second training set are sequentially associated with at least one image of the first training set; and
train the detector model using the first training set, the second training set, the first loss function, and a discriminative loss function, wherein the detector model learns an instance identifier from the known object location of the one or more objects of the first training set and the second training set using the discriminative loss function, the instance identifier expressing a temporal consistency of the one or more objects along a temporal axis, wherein the detector model is trained through an intermediate multidimensional feature predicted at each pixel location of the one or more objects of the first training set and the second training set, the intermediate multidimensional feature being the instance identifier.

16. The non-transitory computer-readable medium of claim 15, wherein, after the detector model is trained with the first training set, the second training set, the first loss function, and the discriminative loss function, the detector model is configured to output, for a detected object within an input image, a detected object location, a detected class label, and a detected instance identifier indicating a consistency of the detected object along the temporal axis.

17. The non-transitory computer-readable medium of claim 16, further comprising instructions that, when executed by one or more processors, cause the one or more processors to output the instance identifier to an object tracking system.

18. The non-transitory computer-readable medium of claim 17, further comprising instructions that, when executed by one or more processors, cause the one or more processors to determine, by the object tracking system, an instance similarity based on the instance identifier.

19. The non-transitory computer-readable medium of claim 15, wherein the images of the first training set and the second training set are RGB images captured by a camera mounted to a vehicle.

20. The non-transitory computer-readable medium of claim 15, wherein the intermediate multidimensional feature is one of an eight-dimensional feature vector or a twelve-dimensional feature vector.
